(19) United States
(12) Patent Application Publication
(10) Pub. No.: US 2023/0295476 A1
(43) Pub. Date: Sep. 21, 2023

(54) ADHESIVE COMPOSITION, ADHESIVE, ADHESIVE SHEET, AND ADHESIVE SHEET FOR IMAGE DISPLAY DEVICE

(71) Applicant: Mitsubishi Chemical Corporation, Tokyo (JP)

(72) Inventor: Tetsuya Asano, Tokyo (JP)

(73) Assignee: Mitsubishi Chemical Corporation, Tokyo (JP)

(21) Appl. No.: 18/199,673

(22) Filed: May 19, 2023

Related U.S. Application Data
(63) Continuation of application No. PCT/JP2021/043318, filed on Nov. 26, 2021.

(30) Foreign Application Priority Data
Nov. 27, 2020 (JP) 2020-196784

(51) Int. Cl. C09J 133/08

(52) U.S. Cl. CPC C09J 133/08

(57) ABSTRACT

The present disclosure provides an adhesive composition comprising an acrylic resin (A) and a hydrophilicity imparting agent (B), wherein the acrylic resin (A) is a copolymer of a copolymerization component (a) containing a methacrylic acid alkyl ester monomer having an alkyl chain with 10 to 36 carbon atoms (a1), and a polar group-containing ethylenic unsaturated monomer (a2), the content of the polar group-containing ethylenic unsaturated monomer (a2) is less than 3 wt. % with respect to the copolymerization component (a), and the hydrophilicity imparting agent (B) contains a compound (B1) that has a structure represented by —(CₙH₂ₙO)ₘ— (n is 2 to 6 and m is 2 to 25) and contains at least one ethylenic unsaturated group.

### RELATED APPLICATIONS

This application is a continuation of International Application No. PCT/JP2021/043318, filed on Nov. 26, 2021, which claims priority to Japanese Patent Application No. 2020-196784, filed on Nov. 27, 2020, the entire contents of each of which being herein incorporated by reference.

### TECHNICAL FIELD

The present disclosure relates to an adhesive composition, an adhesive made of the adhesive composition, an adhesive sheet, and an adhesive sheet for an image display device. Specifically, the present disclosure relates to an adhesive composition that has excellent adhesive properties and excellent moisture and heat resistance and exhibits a low dielectric constant and a low dielectric dissipation factor, an adhesive made of the adhesive composition, an adhesive sheet, and an adhesive sheet for an image display device.

### BACKGROUND ART

Recent years have seen touch panels formed by combining a display and a locator device being widely used in televisions, personal computer monitors, and mobile devices such as laptop computers, cellular phones, smartphones, and tablet devices. In particular, capacitive touch panels are increasingly being used.

Touch panels typically include an organic EL display or liquid crystal display, a transparent conductive film substrate (ITO substrate), and a protective film (glass), and transparent adhesive sheets are used to bond these members together.

Adhesives for such transparent adhesive sheets are required to have adhesive properties such as adhesiveness as well as shock absorbency for preventing a display from being damaged due to an external impact, and excellent optical properties (transparency). Furthermore, the adhesives are required to have a low dielectric constant and the like in order to suppress malfunctioning of a touch panel caused by noise generated by a display member and other peripheral members.

Examples of known adhesives having a low dielectric constant include an adhesive formed using a (meth)acrylic polymer obtained through polymerization of a monomer component that includes, as a main component, alkyl (meth)acrylate having a branched alkyl chain with 10 to 18 carbon atoms at a terminus of an ester group (see PTL 1, for example), an adhesive formed using a copolymer of a monomer mixture that includes monomers containing, in certain amounts, a methacrylic acid alkyl ester monomer having a long alkyl chain with 10 or more carbon atoms in an alkyl ester moiety and a methacrylic acid alkyl ester monomer having an alkyl chain with 1 to 9 carbon atoms in an alkyl ester moiety (see PTL 2, for example), and an adhesive composition containing a methacrylic polymer that is obtained through polymerization of a monomer component containing, in an amount of 40 to 99.5 wt. %, a methacrylic acid alkyl ester having a C10 to C18 alkyl chain in the side chain and that has a glass-transition temperature (Tg) of 0° C. or lower (see PTL 3, for example).

### CITATION LIST

### Patent Literature

PTL 1: JP 2012-246477A

PTL 2: JP 2015-40237A

PTL 3: JP 2013-1761A

### SUMMARY

### Technical Problem

However, in recent years, adhesives are being required to have lower dielectric properties, particularly a lower dielectric dissipation factor, in a high-frequency band (millimeter wave band) than before as the frequency of transmission signals is being increased. Under these circumstances, adhesives having a low dielectric constant can be obtained through the technologies disclosed in PTL 1 and PTL 2, but their dielectric dissipation factors are insufficiently low, and further improvements are required.

Moreover, with the technology disclosed in PTL 3, favorable low dielectric properties are achieved, but the adhesive properties and moisture-and-heat resistance of the adhesive are unsatisfactory, and thus it is difficult to achieve well-balanced low dielectric properties, adhesive properties, and moisture-and-heat resistance.

Under the above circumstances, the present disclosure provides an adhesive composition that has excellent adhesive properties and excellent moisture-and-heat resistance and exhibits a low dielectric constant and a low dielectric dissipation factor.

### Solution to Problem

In view of the foregoing circumstances, the inventor of the present disclosure carried out intensive studies and found that using, in an adhesive composition that includes an acrylic resin, a certain hydrophilicity imparting agent and an acrylic resin obtained through copolymerization of a copolymerization component that contains a methacrylic acid alkyl ester monomer having an alkyl chain with many carbon atoms and a certain amount of a polar group-containing (meth)acrylic acid ester monomer and serves as a copolymerization component for forming the acrylic resin makes it possible to obtain an acrylic adhesive composition capable of forming an adhesive that has excellent adhesive properties and excellent moisture-and-heat resistance and exhibits a low dielectric constant and a low dielectric dissipation factor.

Specifically, the gist of the present disclosure includes [1] to [11] below.
[1] An adhesive composition containing: an acrylic resin (A); and a hydrophilicity imparting agent (B),
wherein the acrylic resin (A) is a copolymer of a copolymerization component (a) containing a methacrylic acid alkyl ester monomer having an alkyl chain with 10 to 36 carbon atoms (al), and a polar group-containing ethylenic unsaturated monomer (a2),
a content of the polar group-containing ethylenic unsaturated monomer (a2) is less than 3 wt. % with respect to the copolymerization component (a), and
the hydrophilicity imparting agent (B) contains a compound (B1) that has a structure represented by —(CₙH₂ₙO)m- (n is 2 to 6 and m is 2 to 25) and contains at least one ethylenic unsaturated group.
[2] The adhesive composition according to [1], wherein a content of the methacrylic acid alkyl ester monomer having an alkyl chain with 10 to 36 carbon atoms (a1) in the copolymerization component (a) is 50 to 95 wt. % with respect to the copolymerization component (a).
[3] The adhesive composition according to [1] or [2], wherein the methacrylic acid alkyl ester monomer having an alkyl chain with 10 to 36 carbon atoms (a1) contains a methacrylic acid alkyl ester monomer having an alkyl chain with 10 to 15 carbon atoms (a1-1) and a methacrylic acid alkyl ester monomer having an alkyl chain with 16 to 36 carbon atoms (a1-2).
[4] The adhesive composition according to any one of [1] to [3], wherein a content of methacrylic acid alkyl ester monomers in the copolymerization component (a) is 80 to 99 wt. % with respect to the copolymerization component (a), and the average of the number of carbon atoms in alkyl chains of the methacrylic acid alkyl ester monomers is 10 to 15.
[5] The adhesive composition according to any one of [1] to [4], wherein the acrylic resin (A) has an active energy ray cross-linkable structural moiety.
[6] The adhesive composition according to [5], wherein the active energy ray cross-linkable structural moiety is a benzophenone cross-linkable structural moiety.
[7] The adhesive composition according to any one of [1] to [6], wherein the acrylic resin (A) has a weight-average molecular weight of 150,000 to 1,500,000.
[8] An adhesive formed by cross-linking the adhesive composition according to any one of [1] to [7].
[9] An adhesive formed by cross-linking the adhesive composition according to any one of [1] to [7] using an active energy ray.
[10] An adhesive sheet having an adhesive layer made of the adhesive according to [8] or [9].
[11] An adhesive sheet for an image display device having an adhesive layer made of the adhesive according to [8] or [9].

### Advantageous Effects of Invention

An adhesive obtained using the adhesive composition according to the present disclosure has excellent adhesive properties and excellent moisture-and-heat resistance and exhibits a low dielectric constant and a low dielectric dissipation factor, and is particularly useful as an adhesive to be used to bond optical members included in a touch panel, image display device, and the like.

It is commonly known that, in order to impart an adhesive composition in which an acrylic resin is used, with low dielectric properties (low dielectric constant and low dielectric dissipation factor), the amount of an alkyl (meth)acrylic acid ester monomer having an alkyl chain with 10 or more carbon atoms used in copolymerization is increased to reduce the molecular dipole moment.

However, adhesive properties such as adhesiveness and holding force of an acrylic resin formed through copolymerization of a copolymerization component having an alkyl chain with many carbon atoms tend to be particularly poor at high temperatures. Accordingly, in order to solve this problem, an acid or the like is commonly introduced as a functional group, but a low dielectric dissipation factor is less likely to be achieved in a high-frequency band if a highly polar functional group is introduced. The present disclosure is achieved based on the finding that excellent adhesive properties and excellent moisture-and-heat resistance are achieved, and low dielectric properties, particularly a low dielectric dissipation factor, are exhibited by using, in combination, a certain hydrophilicity imparting agent and an acrylic resin obtained using a methacrylic acid alkyl ester monomer having an alkyl chain with a predetermined length and a polar group-containing (meth)acrylic acid ester monomer.

### DESCRIPTION OF EMBODIMENT

Hereinafter, the present disclosure will be described in detail. However, the following description is directed to an example of desirable aspects.

Note that, in the present disclosure, the terms “(meth)acryl,” “(meth)acryloyl,” and “(meth)acrylate” mean acryl or methacryl, acryloyl or methacryloyl, and acrylate or methacrylate, respectively, and an “acrylic resin” is a resin obtained through polymerization of a monomer component that contains at least one (meth)acrylic monomer. The term “sheet” encompasses the concepts of a sheet, a film, and tape.

An adhesive composition according to the present disclosure contains an acrylic resin (A) and a hydrophilicity imparting agent (B), wherein the acrylic resin (A) is a copolymer of a copolymerization component (a) containing a methacrylic acid alkyl ester monomer having an alkyl chain with 10 to 36 carbon atoms (a1) (which may be referred to merely as a “methacrylic acid alkyl ester monomer (a1)” hereinafter) and a certain amount of a polar group-containing ethylenic unsaturated monomer (a2), and the hydrophilicity imparting agent (B) includes a compound (B1) that has a structure represented by —(CₙH₂ₙO)m- (n is 2 to 6 and m is 2 to 25) and contains at least one ethylenic unsaturated group. The components used in the present disclosure will be described below.

As described above, the acrylic resin (A) used in the present disclosure is a copolymer of the copolymerization component (a) containing the methacrylic acid alkyl ester monomer (a1) and a certain amount of the polar group-containing ethylenic unsaturated monomer (a2). The monomers contained in the copolymerization component (a) will be described below.

### Methacrylic Acid Alkyl Ester Monomer Having Alkyl Chain with 10 to 36 Carbon Atoms (a1)

Examples of the methacrylic acid alkyl ester monomer having an alkyl chain with 10 to 36 carbon atoms (al) used in the present disclosure include linear aliphatic methacrylates such as decyl methacrylate, lauryl methacrylate, tridecyl methacrylate, cetyl methacrylate, stearyl methacrylate, and myristyl methacrylate, and branched aliphatic methacrylates such as isodecyl methacrylate, isotridecyl methacrylate, isomyristyl methacrylate, isostearyl methacrylate, and isotetracocyl methacrylate. These may be used alone or in combination of two or more. Of these monomers, lauryl methacrylate, tridecyl methacrylate, and stearyl methacrylate are preferable in terms of achieving both low dielectric properties and adhesive properties.

The content of the methacrylic acid alkyl ester monomer (a1) is usually 50 to 95 wt. %, preferably 55 to 90 wt. %, and particularly preferably 60 to 85 wt. %, with respect to the copolymerization component (a), in terms of a low dielectric constant and excellent adhesive properties.

If the content is too low, the relative dielectric constant tends to increase, or the thermal stability of the acrylic resin (A) tends to decrease. If the content is too high, the adhesiveness tends to decrease.

It is preferable that a methacrylic acid alkyl ester monomer having an alkyl chain with 10 to 15 carbon atoms (a1-1) (which may be referred to merely as a “methacrylic acid alkyl ester monomer (a1-1)” hereinafter) and a methacrylic acid alkyl ester monomer having an alkyl chain with 16 to 36 carbon atoms (a1-2) (which may be referred to merely as a “methacrylic acid alkyl ester monomer (a1-2)” hereinafter) are contained as the methacrylic acid alkyl ester monomer (a1), in terms of low dielectric properties.

Examples of the methacrylic acid alkyl ester monomer (a1-1) include linear aliphatic methacrylates such as decyl methacrylate, lauryl methacrylate, and tridecyl methacrylate, and branched aliphatic methacrylates such as isodecyl methacrylate and isotridecyl methacrylate. These may be used alone or in combination of two or more. Of these monomers, the linear aliphatic methacrylates are preferable, and lauryl methacrylate and tridecyl methacrylate are more preferable, in terms of achieving both low dielectric properties and adhesive properties.

The content of the methacrylic acid alkyl ester monomer (a1-1) is preferably 30 to 85 wt. %, more preferably 40 to 80 wt. %, and particularly preferably 50 to 75 wt. %, with respect to the copolymerization component (a), in terms of achieving both low dielectric properties and adhesive properties.

If the content is too low, the relative dielectric constant tends to increase, or the thermal stability of the acrylic resin (A) tends to decrease. If the content is too high, the adhesive properties tend to decrease.

Examples of the methacrylic acid alkyl ester monomer (a1-2) include linear aliphatic methacrylates such as cetyl methacrylate, stearyl methacrylate, and myristyl methacrylate, and branched aliphatic methacrylates such as isomyristyl methacrylate, isostearyl methacrylate, and isotetracocyl methacrylate. These may be used alone or in combination of two or more. Of these monomers, methacrylates having an alkyl chain with 18 to 24 carbon atoms are preferable, and stearyl methacrylate is more preferable, in terms of ease of increasing monomer conversion during copolymerization, and achieving both low dielectric properties and adhesive properties.

The content of the methacrylic acid alkyl ester monomer (a1-2) is usually 1 to 50 wt. %, preferably 5 to 40 wt. %, and particularly preferably 10 to 30 wt. %, with respect to the copolymerization component (a), in terms of the relative dielectric constant and adhesive properties.

If the content is too low, the relative dielectric constant tends to increase. If the content is too high, the adhesive properties tend to decrease.

The content ratio (a1-1/a1-2) between the methacrylic acid alkyl ester monomer (a1-1) and the methacrylic acid alkyl ester monomer (a1-2) in the copolymerization component (a) is usually 1/99 to 99/1, preferably 30/70 to 95/5, and more preferably 55/45 to 90/10. When the content ratio between the methacrylic acid alkyl ester monomer (a1-1) and the methacrylic acid alkyl ester monomer (a1-2) is within the range above, low dielectric properties tend to be excellent.

### Polar Group-Containing Ethylenic Unsaturated Monomer (a2)

Examples of the polar group-containing ethylenic unsaturated monomer (a2) include a hydroxy group-containing monomer, a carboxy group-containing monomer, an amino group-containing monomer, an amide group-containing monomer, and a cyano group-containing monomer. These may be used alone or in combination of two or more. Of these monomers, the hydroxy group-containing monomer is preferable in terms of excellent adhesive properties and excellent reactivity with a thermal cross-linking agent (D), which will be described later.

Examples of the hydroxy group-containing monomer include: primary hydroxy group-containing monomers such as (meth)acrylic acid hydroxyalkyl ester monomers (e.g., 2-hydroxyethyl (meth)acrylate, 4-hydroxybutyl (meth)acrylate, 5-hydroxypentyl (meth)acrylate, 6-hydroxyhexyl (meth)acrylate, and 8-hydroxyoctyl (meth)acrylate), caprolactone-modified monomers (e.g., caprolactone-modified 2-hydroxyethyl (meth)acrylate), oxyalkylene-modified monomers (e.g., diethylene glycol (meth)acrylate and polyethylene glycol (meth)acrylate), and others (e.g., 2-acryloyloxyethyl-2-hydroxyethyl phthalate, N-methylol (meth)acrylamide, and hydroxyethyl acrylamide); secondary hydroxy group-containing monomers such as 2-hydroxypropyl (meth)acrylate, 2-hydroxybutyl (meth)acrylate, and 3-chloro 2-hydroxypropyl (meth)acrylate; and tertiary hydroxy group-containing monomers such as 2,2-dimethyl 2-hydroxyethyl (meth)acrylate. Of these monomers, (meth)acrylic acid hydroxyalkyl ester monomers are preferable, 2-hydroxyethyl (meth)acrylate and 4-hydroxybutyl (meth)acrylate are more preferable in terms of few impurities such as di(meth)acrylate and ease of production, and 4-hydroxybutyl acrylate is particularly preferable.

Examples of the carboxy group-containing monomers include (meth)acrylic acid, β-carboxyethyl (meth)acrylate, crotonic acid, maleic acid, maleic anhydride, fumaric acid, citraconic acid, glutaconic acid, itaconic acid, glycolic acid, and cinnamic acid.

Examples of the amino group-containing monomer include dimethylaminoethyl (meth)acrylate, diethylaminoethyl (meth)acrylate, and quaternized products thereof.

Examples of the amide group-containing monomers include (meth)acrylamide, N-(n-butoxyalkyl) (meth)acrylamide, N,N-dimethyl (meth)acrylamide, N,N-diethyl (meth)acrylamide, vinylpyrrolidone, and acryloyl morpholine.

Examples of the cyano group-containing monomer include acrylonitrile and methacrylonitrile.

The content of the polar group-containing ethylenic unsaturated monomer (a2) is less than 3 wt. %, preferably 0.01 wt. % or more and less than 3 wt. %, more preferably 0.05 wt. % or more and 2.5 wt. % or less, even more preferably 0.1 wt. % or more and 2 wt. % or less, and particularly preferably 0.2 wt. % or more and 1 wt. % or less, with respect to the copolymerization component (a), in terms of achieving both low dielectric properties and adhesive properties.

If the content is too high, the relative dielectric constant and the dielectric dissipation factor tend to increase. If the content is too low, compatibility with the hydrophilicity imparting agent (B), which will be described later, the adhesive properties, and the durability tend to decrease.

It is preferable that the copolymerization component (a) used in the present disclosure contains a methacrylic acid alkyl ester monomer having an alkyl chain with 1 to 9 carbon atoms (a3) (which may be referred to merely as a “methacrylic acid alkyl ester monomer (a3)” hereinafter) in addition to the methacrylic acid alkyl ester monomer (a1) and the polar group-containing ethylenic unsaturated monomer (a2), in terms of adhesiveness.

### Methacrylic Acid Alkyl Ester Monomer Having Alkyl Chain with 1 to 9 Carbon Atoms (a3)

Examples of the methacrylic acid alkyl ester monomer (a3) include linear aliphatic methacrylates such as methyl methacrylate, ethyl methacrylate, propyl methacrylate, n-butyl methacrylate, and n-hexyl methacrylate, branched aliphatic methacrylates such as iso-butyl methacrylate, tert-butyl methacrylate, and 2-ethylhexyl methacrylate, and cyclic aliphatic methacrylates such as cyclohexyl methacrylate. These may be used alone or in combination of two or more. Of these monomers, ethyl methacrylate is preferable in terms of compatibility with the hydrophilicity imparting agent (B), which will be described later, and moisture-and-heat resistance, and 2-ethylhexyl methacrylate is preferable in terms of a cohesive force and low dielectric properties.

The content of the methacrylic acid alkyl ester monomer (a3) is usually 1 to 50 wt. %, preferably 5 to 40 wt. %, and particularly preferably 10 to 35 wt. %, with respect to the copolymerization component (a). If the content is too low, the adhesiveness tends to be insufficient. If the content is too high, the adhesive properties and handleability at high temperatures tend to decrease.

The content ratio (a1/a3) between the methacrylic acid alkyl ester monomer (a1) and the methacrylic acid alkyl ester monomer (a3) in the copolymerization component (a) used in the present disclosure is preferably 50/50 to 95/5 on a weight basis. The content ratio is more preferably 55/45 to 93/7, and particularly preferably 60/40 to 90/10. When the content ratio (a1/a3) is within the range above, adhesive properties and low dielectric properties tend to be excellent.

### Active Energy Ray Cross-Linkable Structural Moiety-Containing (Meth)Acrylic Acid Ester Monomer (a4)

In the present disclosure, it is preferable to use an active energy ray cross-linkable structural moiety-containing (meth)acrylic acid ester monomer (a4) in the copolymerization component (a) of the acrylic resin (A) in terms of an ability to efficiently cure (cross-link) the acrylic resin (A) and increase the cohesive force.

It is preferable that a (meth)acrylic acid ester monomer having a benzophenone cross-linkable structure is contained as the active energy ray cross-linkable structural moiety-containing (meth)acrylic acid ester monomer (a4) in terms of an ability to form an efficient cross-linked structure using active energy rays such as ultraviolet rays or an electron beam. An example of the (meth)acrylic acid ester monomer having a benzophenone cross-linkable structure is 4-(meth)acryloyloxy benzophenone.

An acrylic resin (A) obtained through copolymerization of the active energy ray cross-linkable structural moiety-containing (meth)acrylic acid ester monomer (a4) has an active energy ray cross-linkable structural moiety, and the active energy ray cross-linkable structural moiety can react with a portion of the acrylic resin (A) or another curable component included in the adhesive composition through irradiation with an active energy ray to form a cross-linked structure.

The content of the active energy ray cross-linkable structural moiety-containing (meth)acrylic acid ester monomer (a4) is preferably 0.01 to 5 wt. % with respect to the copolymerization component (a) in terms of the holding force, efficient production, and adhesiveness during the formation of the cross-linked structure using an active energy ray. In particular, the content of a (meth)acrylic acid ester monomer having a benzophenone structure is preferably 0.01 to 5 wt. %, particularly preferably 0.1 to 2 wt. %, and more preferably 0.2 to 1 wt. %, with respect to the copolymerization component (a). If the content is too low, the holding force during the formation of the cross-linked structure using an active energy ray tends to decrease. Furthermore, when a cross-linked structure is formed in order to produce a processible adhesive sheet, the amount of active energy rays needs to be increased, and thus a large amount of energy is needed to produce the adhesive sheet, making it difficult to realize efficient production. If the content is too high, the cohesive force of the entire system tends to increase excessively, which leads to a decrease in the adhesiveness.

It is also possible to introduce an active energy ray cross-linkable structural moiety in the acrylic resin (A) by introducing a hydroxy group into the acrylic resin (A) in advance and reacting an ethylenic unsaturated group-containing isocyanate compound with the hydroxy group to introduce an ethylenic unsaturated group as the active energy ray cross-linkable structural moiety.

In the present disclosure, the copolymerization component (a) may further contain another copolymerizable ethylenic unsaturated monomer (a5) as necessary.

### Another Polymerizable Ethylenic Unsaturated Monomer (a5)

Examples of the other polymerizable ethylenic unsaturated monomer (a5) include: acrylic acid alkyl ester monomers having an alkyl chain with 1 to 9 carbon atoms such as methyl acrylate, ethyl acrylate, propyl acrylate, n-butyl acrylate, iso-butyl acrylate, tert-butyl acrylate, n-hexyl acrylate, 2-ethylhexyl acrylate, and cyclohexyl acrylate; aromatic ring-containing monomers such as phenyl (meth)acrylate, benzyl (meth)acrylate, phenoxyethyl (meth)acrylate, phenyl diethylene glycol (meth)acrylate, 2-hydroxy-3-phenoxypropyl (meth)acrylate, phenoxy polyethylene glycol (meth)acrylate, phenoxy polyethylene glycol-polypropylene glycol-(meth)acrylate, ortho-phenylphenoxyethyl (meth)acrylate, and nonylphenol ethylene oxide adduct (meth)acrylate; alicyclic monomers such as cyclohexyl acrylate, cyclohexyloxyalkyl (meth)acrylate, tert-butylcyclohexyloxyethyl (meth)acrylate, isobornyl (meth)acrylate, and dicyclopentanyl (meth)acrylate; ether chain-containing monomers such as 2-methoxyethyl (meth)acrylate, 2-ethoxyethyl (meth)acrylate, 3-methoxybutyl (meth)acrylate, 2-butoxyethyl (meth)acrylate, 2-butoxy diethylene glycol (meth)acrylate, methoxy diethylene glycol (meth)acrylate, methoxy triethylene glycol (meth)acrylate, ethoxy diethylene glycol (meth)acrylate, methoxy dipropylene glycol (meth)acrylate, methoxy polyethylene glycol (meth)acrylate, octoxy polyethylene glycol-polypropylene glycol mono(meth)acrylate, lauroxy polyethylene glycol mono(meth)acrylate, and stearoxy polyethylene glycol mono(meth)acrylate; and other monomers such as styrene, α-methylstyrene, vinyl acetate, vinyl propionate, vinyl stearate, vinyl chloride, vinylidene chloride, alkyl vinyl ether, vinyl toluene, vinyl pyridine, itaconic acid dialkyl ester, fumaric acid dialkyl ester, allyl alcohol, acryl chloride, methyl vinyl ketone, N-acrylamide methyl trimethyl ammonium chloride, allyl trimethyl ammonium chloride, and dimethyl allyl vinyl ketone.

These may be used alone or in combination of two or more.

In order to increase the molecular weight of the acrylic resin (A), compounds having two or more ethylenic unsaturated groups such as ethylene glycol di(meth)acrylate, diethylene glycol di(meth)acrylate, triethylene glycol di(meth)acrylate, polyethylene glycol di(meth)acrylate, propylene glycol di(meth)acrylate, and divinyl benzene can also be used together as the other polymerizable ethylenic unsaturated monomer (a5).

The content of the other polymerizable ethylenic unsaturated monomer (a5) is usually 20 wt. % or less, preferably 10 wt. % or less, and more preferably 5 wt. % or less, with respect to the copolymerization component (a).

If the content is too high, the dielectric properties and adhesiveness tend to decrease.

The acrylic resin (A) used in the present disclosure can be manufactured through copolymerization of the copolymerization component (a) that includes the methacrylic acid alkyl ester monomer (a1) and polar group-containing ethylenic unsaturated monomer (a2) as essential components, and, as appropriate, the methacrylic acid alkyl ester monomer (a3), the active energy ray cross-linkable structural moiety-containing (meth)acrylic acid ester monomer (a4), and the other copolymerizable ethylenic unsaturated monomer (a5).

The content of the methacrylic acid alkyl ester monomers in the copolymerization component (a) is preferably 80 to 99 wt. %, more preferably 90 to 99 wt. %, and particularly preferably 95 to 99 wt. %, with respect to the copolymerization component (a), in terms of low dielectric properties, particularly a low dielectric dissipation factor. In particular, the total content of the methacrylic acid alkyl ester monomer (al) and the methacrylic acid alkyl ester monomer (a3) is preferably within the range above with respect to the copolymerization component (a).

Furthermore, the average of the number of carbon atoms in the alkyl chains of the methacrylic acid alkyl ester monomers contained in the copolymerization component (a) is preferably 10 to 15, and more preferably 11 to 14, in terms of low dielectric properties, particularly a low dielectric dissipation factor. In particular, the average of the number of carbon atoms in the alkyl chains of the methacrylic acid alkyl ester monomer (a1) and the methacrylic acid alkyl ester monomer (a3) is preferably within the range above.

Conventionally known polymerization methods such as solution polymerization, suspension polymerization, bulk polymerization, and emulsion polymerization can be used as a polymerization method of the acrylic resin (A). In the present disclosure, solution polymerization is preferable because an acrylic resin (A) having any monomer composition can be manufactured safely and stably.

An example of a favorable manufacturing method of the acrylic resin (A) used in the present disclosure will be described below.

First, the copolymerization component and a polymerization initiator are mixed in or dripped into an organic solvent to initiate solution polymerization.

Examples of the organic solvent used in the polymerization reaction include: aromatic hydrocarbons such as toluene and xylene; aliphatic hydrocarbons such as n-hexane; esters such as methyl acetate, ethyl acetate, and butyl acetate; aliphatic alcohols such as methyl alcohol, ethyl alcohol, n-propyl alcohol, and isopropyl alcohol; ketones such as acetone, methyl ethyl ketone, methyl isobutyl ketone, and cyclohexanone; aliphatic ethers such as dimethyl ether and diethyl ether; halogenated aliphatic hydrocarbons such as methylene chloride and ethylene chloride; and cyclic ethers such as tetrahydrofuran. These may be used alone or in combination of two or more. Of these solvents, the esters and the ketones are preferable, and ethyl acetate and acetone are particularly preferable.

Examples of the polymerization initiator used in the polymerization reaction include azo polymerization initiators and peroxide polymerization initiators, which are common radical polymerization initiators. Examples of the azo polymerization initiators include 2,2′-azobis(2-methylbutyronitrile), 2,2′-azobisisobutyronitrile, (1-phenylethyl)azodiphenylmethane, 2,2′-azobis(2,4-dimethylvaleronitrile), 2,2′-azobis(2-cyclopropylpropionitrile), and 2,2′-azobis(4-methoxy-2,4-dimethylvaleronitrile). Examples of the peroxide polymerization initiators include benzoyl peroxide, di-tert-butyl peroxide, cumene hydroperoxide, lauroyl peroxide, tert-butyl peroxypivalate, tert-hexyl peroxypivalate, tert-hexyl peroxyneodecanoate, diisopropyl peroxycarbonate, and diisobutyryl peroxide. These may be used alone or in combination of two or more. Of these polymerization initiators, the azo polymerization initiators are preferable, and 2,2′-azobisisobutyronitrile and 2,2′-azobis(4-methoxy-2,4-dimethylvaleronitrile) are more preferable.

The amount of the polymerization initiator used is usually 0.001 to 10 parts by weight, preferably 0.1 to 8 parts by weight, particularly preferably 0.5 to 6 parts by weight, more preferably 1 to 4 parts by weight, even more preferably 1.5 to 3 parts by weight, and most preferably 2 to 2.5 parts by weight, with respect to 100 parts by weight of the copolymerization component (a). If the amount of the polymerization initiator used is too small, residual monomers tend to increase due to a decrease in the degree of polymerization of the acrylic resin (A), or the weight-average molecular weight of the acrylic resin (A) tends to increase. If the amount of the polymerization initiator used is too large, the acrylic resin (A) is likely to become a gel.

It is sufficient that the polymerization conditions for the solution polymerization are determined in accordance with conventionally known polymerization conditions. For example, the copolymerization component (a) containing the (meth)acrylic monomers and the polymerization initiator are mixed in or dripped into a solvent, and then polymerization can be performed under predetermined polymerization conditions.

The polymerization temperature in the polymerization reaction is usually 40 to 120° C. However, in the present disclosure, the polymerization temperature is preferably 50 to 90° C. in terms of a stable reaction. If the polymerization temperature is too high, the acrylic resin (A) is likely to become a gel. If the polymerization temperature is too low, the activity of the polymerization initiator decreases, and thus residual monomers tend to increase due to a decrease in the degree of polymerization.

Although there is no particular limitation on the polymerization time of the polymerization reaction, the polymerization reaction is preferably performed for 0.5 hours or more since the addition of the last polymerization initiator, preferably 1 hour or more, more preferably 2 hours or more, and particularly preferably 5 hours or more.

Note that, in terms of ease of heat removal, it is preferable to perform the polymerization reaction while refluxing the solvent.

As described above, the acrylic resin (A) used in the present disclosure can be manufactured.

### Acrylic Resin (A)

The weight-average molecular weight of the acrylic resin (A) is preferably 150,000 to 1,500,000, more preferably 200,000 to 1,000,000, particularly preferably 250,000 to 800,000, and even more preferably 300,000 to 600,000. If the weight-average molecular weight is too large, ease of coating and handleability tend to decrease due to an excessive increase in viscosity. If the weight-average molecular weight is too small, the adhesive properties tend to decrease due to a decrease in a cohesive force.

Note that the weight-average molecular weight of the acrylic resin (A) is a weight-average molecular weight at the end of manufacturing, that is to say, the weight-average molecular weight of an acrylic resin (A) that is not subjected to a heating process and the like after being manufactured.

The degree of dispersion (weight-average molecular weight/number-average molecular weight) of the acrylic resin (A) is preferably 15 or less, more preferably 10 or less, particularly preferably 7 or less, and even more preferably 5 or less. If the degree of dispersion is too high, the adhesive layer is likely to foam due to a decrease in durability. If the degree of dispersion is too low, handleability tends to decrease. Note that the lower limit of the degree of dispersion is usually 1.1 in terms of the manufacturing limitation.

The weight-average molecular weight is a weight-average molecular weight that is based on a standard polystyrene molecular weight and is measured using a high-speed liquid chromatograph (manufactured by Nihon Waters K.K., “Waters 2695 (apparatus main body)” and “Waters 2414 (detector)”) and three columns Shodex GPC KF-806L (each having an exclusion limit molecular weight of 2×10⁷, a separation range of 100 to 2×10⁷, a theoretical plate number of 10,000 per column, and filled with a column packing material of styrene-divinylbenzene copolymer having a particle diameter of 10 μm) connected in series. The number-average molecular weight can be measured using the same method. The degree of dispersion can be determined from the weight-average molecular weight and the number-average molecular weight.

The glass-transition temperature (Tg) of the acrylic resin (A) used in the present disclosure is preferably −100 to 50° C., particularly preferably −50 to 20° C., and even more preferably −15 to 10° C. If the glass-transition temperature is too high, the adhesiveness tends to decrease due to a decrease in the step following ability and adhesion. If the glass-transition temperature is too low, the low dielectric properties in a high-frequency band tend to be impaired, and the adhesive properties at high temperatures tend to decrease.

The glass-transition temperature (Tg) can be determined using the measurement method below.

A release sheet is removed from an adhesive sheet that is not yet subjected to irradiation with an active energy ray, which will be described later, and a plurality of adhesive sheets are stacked to produce an adhesive sheet with a thickness of about 650 μm in an uncross-linked state. The dynamic viscoelasticity of the produced sheet is measured under the following conditions, and a temperature at which the dissipation factor (loss elastic modulus G″/storage elastic modulus G′=tan δ) is the largest is read and is taken as the glass-transition temperature (Tg) of the acrylic resin (A).

Measurement Conditions
Measurement apparatus: DVA-225 (manufactured by IT Measurement Control Co., Ltd.)
Deformation mode: shearing
Distortion: 0.1%
Measurement temperature: −100 to 60° C.
Measurement frequency: 1 Hz

The content of the acrylic resin (A) in the adhesive composition according to the present disclosure is preferably 90 wt. % or more, more preferably 95 to 99.9 wt. %, particularly preferably 98 to 99.8 wt. %, and even more preferably 99 to 99.5 wt. %, with respect to the entire adhesive composition.

### Hydrophilicity Imparting Agent (B)

The adhesive composition according to the present disclosure contains a hydrophilicity imparting agent (B), and the hydrophilicity imparting agent (B) contains a compound (B1) (abbreviated as a “hydrophilicity imparting agent (B1)” hereinafter) that has a structure represented by —(CₙH₂ₙO)m- (n is 2 to 6 and m is 2 to 25) and contains at least one ethylenic unsaturated group. The symbol n is usually 2 to 6, preferably 2 to 4, and more preferably 2 to 3, in terms of compatibility with the acrylic resin and moisture-and-heat resistance of the obtained adhesive. The symbol m is usually 2 to 25, preferably 4 to 14, and more preferably 5 to 10, in terms of compatibility with the acrylic resin (A) and moisture-and-heat resistance of the obtained adhesive. If the symbol n or m is too large, compatibility with the acrylic resin tends to decrease. If the symbol n or m is too small, the moisture-and-heat resistance tends to decrease.

The moisture-and-heat resistance of the adhesive obtained using the adhesive composition can be improved as a result of the adhesive composition containing the hydrophilicity imparting agent (B1).

Examples of the hydrophilicity imparting agent (B1) include (poly)ethylene glycol mono(meth)acrylate, (poly)butylene glycol mono(meth)acrylate, (poly)ethylene glycol di(meth)acrylate, (poly)propylene glycol di(meth)acrylate, (poly)tetramethylene glycol di(meth)acrylate, (poly)pentamethylene glycol di(meth)acrylate, (poly)hexamethylene glycol di(meth)acrylate, ethylene oxide (EO) modified trimethylolpropane triacrylate, and EO-modified glycerin triacrylate. Note that the hydrophilicity imparting agents (B1) listed above can be used alone or in combination of two or more. Of these hydrophilicity imparting agents, a hydrophilicity imparting agent containing two ethylenic unsaturated groups is preferable in terms of achieving both adhesive properties and moisture-and-heat resistance, and (poly)ethylene glycol di(meth)acrylate is particularly preferable.

The content of the hydrophilicity imparting agent (B1) is preferably 5 parts by weight or less, more preferably 0.01 to 3 parts by weight, and even more preferably 0.1 to 1 part by weight, with respect to 100 parts by weight of the acrylic resin (A), in terms of achieving both adhesiveness or a low dielectric dissipation factor and moisture-and-heat resistance. If the amount of the hydrophilicity imparting agent (B1) is too large, adhesiveness tends to decrease, or a dielectric dissipation factor tends to increase. Note that, if the amount of the hydrophilicity imparting agent (B1) is too small, the moisture-and-heat resistance tends to decrease.

It is preferable that the hydrophilicity imparting agent (B) is constituted by only the hydrophilicity imparting agent (B1). However, a hydrophilicity imparting agent (B) other than the hydrophilicity imparting agent (B1) may also be contained. In the case where the hydrophilicity imparting agent (B) contains a hydrophilicity imparting agent (B) other than the hydrophilicity imparting agent (B1), the content of the hydrophilicity imparting agent (B) is 10 wt. % or less, and preferably 5 wt. % or less, and the lower limit is 0 wt. %.

The adhesive composition according to the present disclosure may also contain a cross-linkable monomer (C), a thermal cross-linking agent (D), a silane coupling agent, and a photopolymerization initiator in addition to the acrylic resin (A) and the hydrophilicity imparting agent (B).

Cross-Linkable Monomer (C)

The cross-linkable monomer (C) is different from the hydrophilicity imparting agent (B), and examples of the cross-linkable monomer (C) include cross-linking agents such as multifunctional monomers. The cohesive force of the entire adhesive layer can be adjusted by adding the cross-linkable monomer (C), thus making it likely that stable adhesive properties can be obtained.

The cross-linkable monomer (C) is preferably a multifunctional monomer containing two or more ethylenic unsaturated groups per molecule, and examples of such a multifunctional monomer include hexanediol di(meth)acrylate, butanediol di(meth)acrylate, 1,9-nonanediol di(meth)acrylate, 1,10-decanediol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, isocyanuric acid ethylene oxide-modified tri(meth)acrylate, tricyclodecane dimethanol di(meth)acrylate, allyl (meth)acrylate, vinyl (meth)acrylate, and urethane (meth)acrylate. Note that the multifunctional monomers listed above can be used alone or in combination of two or more. Of these multifunctional monomers, alkyl (meth)acrylates containing two ethylenic unsaturated groups per molecule are preferable in terms of achieving both adhesive properties and a low dielectric dissipation factor, and 1,9-nonanediol di(meth)acrylate and 1,10-decanediol di(meth)acrylate are particularly preferable.

The content of the cross-linkable monomer (C) is usually 20 parts by weight or less, preferably 0.1 to 10 parts by weight, and particularly preferably 1 to 5 parts by weight, with respect to 100 parts by weight of the acrylic resin (A). If the content of the cross-linkable monomer (C) is too low, the holding force tends to decrease. If the content of the cross-linkable monomer (C) is too high, the adhesiveness tends to decrease.

### Thermal Cross-Linking Agent (D)

The thermal cross-linking agent (D) that can be used in the present disclosure mainly reacts with a polar group derived from the polar group-containing (meth)acrylic acid ester monomer (a2), which is a monomer included in the acrylic resin (A), and thus exhibits excellent adhesiveness. Examples of the thermal cross-linking agent (D) include isocyanate cross-linking agents, epoxy cross-linking agents, aziridine cross-linking agents, melamine cross-linking agents, aldehyde cross-linking agents, amine cross-linking agents, and metallic chelate cross-linking agents. Of these cross-linking agents, the isocyanate cross-linking agents are favorably used in terms of an improvement in adhesion to a base material and reactivity with the acrylic resin (A).

Examples of the isocyanate cross-linking agents include 2,4-tolylene diisocyanate, 2,6-tolylene diisocyanate, hydrogenated tolylene diisocyanate, 1,3-xylylene diisocyanate, 1,4-xylylene diisocyanate, hexamethylene diisocyanate, diphenylmethane-4,4-diisocyanate, isophorone diisocyanate, 1,3-bis(isocyanatomethyl)cyclohexane, tetramethylxylylene diisocyanate, 1,5-naphthalene diisocyanate, triphenylmethane triisocyanate, adducts between these polyisocyanate compounds and a polyol compound such as trimethylolpropane, and biuret products and isocyanurate products of these polyisocyanate compounds.

Of these, isocyanate cross-linking agents having an alicyclic structure and an isocyanurate skeleton are preferable.

Examples of the epoxy cross-linking agents include bisphenol A-epichlorohydrin epoxy resins, ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, sorbitol polyglycidyl ether, polyglycerol polyglycidyl ether, pentaerythritol polyglycidylerythritol, and diglycerol polyglycidyl ether.

Examples of the aziridine cross-linking agents include tetramethylolmethane-tri-β-aziridinylpropionate, trimethylolpropane-tri-β-aziridinylpropionate, N,N′-diphenylmethane-4,4′-bis(1-aziridinecarboxamide), and N,N′-hexamethylene-1,6-bis(1-aziridinecarboxamide).

Examples of the melamine cross-linking agents include hexamethoxymethylmelamine, hexaethoxymethylmelamine, hexapropoxymethylmelamine, hexabutoxymethylmelamine, hexapentyloxymethylmelamine, hexahexyloxymethylmelamine, and melamine resins.

Examples of the aldehyde cross-linking agents include glyoxal, malondialdehyde, succindialdehyde, maleindialdehyde, glutardialdehyde, formaldehyde, acetaldehyde, and benzaldehyde.

Examples of the amine cross-linking agents include hexamethylene diamine, triethyl diamine, polyethylene imine, hexamethylene tetraamine, diethylene triamine, triethyl tetraamine, isophorone diamine, amino resins, and polyamides.

Examples of the metallic chelate cross-linking agents include coordination compounds in which acetylacetone or acetoacetyl ester bonds to a polyvalent metal such as aluminum, iron, copper, zinc, tin, titanium, nickel, antimony, magnesium, vanadium, chromium, or zirconium.

These thermal cross-linking agents (D) may be used alone or in combination of two or more.

The content of the thermal cross-linking agent (D) is usually 10 parts by weight or less, preferably 0.01 to 5 parts by weight, and particularly preferably 0.1 to 3 parts by weight, with respect to 100 parts by weight of the acrylic resin (A). If the content of the thermal cross-linking agent (D) is too low, the cohesive force tends to be insufficient. If the content of the thermal cross-linking agent (D) is too high, the adhesiveness tends to decrease.

### Silane Coupling Agent

The adhesive composition according to the present disclosure may also contain a silane coupling agent in terms of an improvement in durability under high-temperature and high-humidity conditions.

There is no particular limitation on the silane coupling agent, and known silane coupling agents can be used. Examples of the silane coupling agent include: epoxy group-containing silane coupling agents such as 3-glycidoxypropyltrimethoxysilane, 3-glycidoxypropyltriethoxysilane, 3-glycidoxypropylmethyldimethoxysilane, 3-glycidoxypropylmethyldiethoxysilane, and 2-(3,4epoxycyclohexyl)ethyltrimethoxysilane; amino group-containing silane coupling agents such as 3-aminopropyltrimethoxysilane, N-2-(aminoethyl)-3-aminopropylmethyldimethoxysilane, and 3-triethoxysilyl-N-(1,3-dimethylbutylidene)propylamine, (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane. These may be used alone or in combination of two or more. Of these silane coupling agents, 3-glycidoxypropyltrimethoxysilane is preferable.

The content of the silane coupling agent is usually 5 parts by weight or less, preferably 0.01 to 3 parts by weight, and particularly preferably 0.05 to 2 parts by weight, with respect to 100 parts by weight of the acrylic resin (A). If the content of the silane coupling agent is too high, the adhesive properties and transparency tend to decrease due to bleeding. Note that, if the amount of the silane coupling agent is too small, the moisture-and-heat resistance tends to decrease under high-temperature and high-humidity conditions.

### Photopolymerization Initiator

Although an adhesive can be obtained by cross-linking (curing) the adhesive composition according to the present disclosure, a photopolymerization initiator may be further blended in the adhesive composition in order to achieve efficient cross-linking. In particular, in the case where the acrylic resin (A) does not have an active energy ray cross-linkable structural moiety, it is preferable to blend a photopolymerization initiator.

There is no particular limitation on the photopolymerization initiator as long as the photopolymerization initiator generates radicals when being acted upon by light. Examples of the photopolymerization initiator include acetophenone photopolymerization initiators, benzoin photopolymerization initiators, thioxanthone photopolymerization initiators, and acylphosphine oxide photopolymerization initiators. It is preferable to use a hydrogen-abstracting benzophenone photopolymerization initiator in terms of efficient formation of an intermolecular or intramolecular cross-link.

Examples of the benzophenone photopolymerization initiator include benzophenone, benzoylbenzoic acid, 3,3′-dimethyl-4-methoxybenzophenone, and polyvinylbenzophenone. These may be used alone or in combination of two or more.

Assistants for these photopolymerization initiators can be used together, and examples of the assistants include triethanolamine, triisopropanolamine, 4,4′-dimetylaminobenzophenone (Michler's ketone), 4,4′-dietylaminobenzophenone, 2-dimethylaminoethylbenzoic acid, ethyl 4-dimethylaminobenzoate, (n-butoxy)ethyl 4-dimethylaminobenzoate, isoamyl 4-dimethylaminobenzoate, 2-ethylhexyl 4-dimethylaminobenzoate, 2,4-diethylthioxanthone, and 2,4-diisopropylthioxanthone. These assistants may also be used alone or in combination of two or more.

The blend amount of the photopolymerization initiator is preferably 0.01 to 10 parts by weight, particularly preferably 0.1 to 5 parts by weight, and more preferably 0.5 to 2 parts by weight, with respect to 100 parts by weight of the acrylic resin (A). If the blend amount is too small, the curing rate tends to decrease, or the curing degree tends to be insufficient. Even if the blend amount is too large, the ability to cure is not improved, and the cost efficiency tends to decrease.

Another adhesive or conventionally known additives such as a cross-linking accelerator, an antistatic agent, an adhesiveness imparting agent, and a functional dye may also be blended in the adhesive composition according to the present disclosure as necessary. These may be used alone or in combination of two or more.

As described above, the adhesive composition according to the present disclosure can be obtained by mixing the acrylic resin (A) and the hydrophilicity imparting agent (B), and, as necessary, the cross-linkable monomer (C), the thermal cross-linking agent (D), the silane coupling agent, the photopolymerization initiator, and other optional components. Note that there is no particular limitation on the mixing method, and various methods such as a method in which components are mixed all at once, and a method in which some components are mixed and then the rest is mixed into the mixture all at once or successively can be employed.

### Adhesive

As described above, in the acrylic resin (A) included in the adhesive composition according to the present disclosure, at least one selected from the group consisting of an intramolecular cross-linked structure and an intermolecular cross-linked structure is formed by cross-linking (curing) the adhesive composition or irradiating the adhesive composition with an active energy ray in the case where the acrylic resin (A) has an active energy ray cross-linkable structural moiety, and thereby an adhesive is obtained from the adhesive composition. The thus-obtained adhesive has excellent adhesive properties and excellent moisture-and-heat resistance, exhibits a low dielectric constant and a low dielectric dissipation factor, and is favorably used to bond optical members included in a touch panel, image display device, and the like.

The optical members are usually bonded using an adhesive sheet having an adhesive layer constituted by the adhesive composition. The adhesive sheet can be obtained by providing an adhesive layer constituted by the adhesive on a base sheet. Furthermore, a double-sided adhesive sheet can be formed by providing the adhesive layer on a release sheet.

### Adhesive Sheet

The adhesive sheet can be produced as follows, for example.

First, the adhesive composition according to the present disclosure is used as is and applied directly to the base sheet, or an organic solvent is added to the adhesive composition to adjust the concentration and then the mixture is applied directly to the base sheet. Thereafter, the resultant sheet is dried using heat treatment (e.g., at 80 to 105° C. for 0.5 to 10 minutes) or the like, and is then attached to a base sheet or release sheet. Then, the adhesive composition is cross-linked (cured) through irradiation with an active energy ray, and is further aged as necessary. Thus, an adhesive sheet having an adhesive layer made of the adhesive can be produced. Also, a double-sided adhesive sheet free from a base material can be produced by forming the adhesive layer on a release sheet instead of the base sheet and bonding a release sheet to a surface on the opposite side of the adhesive layer.

Before using the obtained adhesive sheet or double-sided adhesive sheet, the release sheet is removed from the adhesive layer.

Examples of the base sheet include: synthetic resin sheets made of polyester resins (e.g., polyethylene naphthenate, polyethylene terephthalate, polybutylene terephthalate, and a polyethylene terephthalate/isophthalate copolymer), polyolefin resins (e.g., polyethylene, polypropylene, and polymethylpentene), polyethylene fluoride resins (e.g., polyvinyl fluoride, polyvinylidene fluoride, and polyethylene fluoride), polyamides (e.g., nylon 6 and nylon 6,6), vinyl polymers (e.g., polyvinyl chloride, a polyvinyl chloride/vinyl acetate copolymer, an ethylene-vinyl acetate copolymer, an ethylene vinyl alcohol copolymer, polyvinyl alcohol, and vinylon), cellulose resins (e.g., cellulose triacetate and cellophane), acrylic resins (e.g., polymethyl methacrylate, polyethyl methacrylate, polyethyl acrylate, and polybutyl acrylate), polystyrene, polycarbonates, polyarylates, polyimides, and the like; metal foils made of aluminum, copper, and iron; paper sheets made of high-quality paper, glassine paper, and the like; and woven fabrics or nonwoven fabrics made of glass fibers, natural fibers, synthetic fibers, and the like. These base sheets can be used in the form of a single-layer structure or a multi-layer structure formed by stacking two or more types of layers. Of these base sheets, the synthetic resin sheets are preferable in terms of weight reduction.

Furthermore, examples of the release sheet include the various synthetic resin sheets listed above as examples of the base sheet, and paper, woven fabrics, nonwoven fabrics, and the like that are imparted with releasability. It is preferable to use a silicone release sheet as the release sheet.

There is no particular limitation on a method for applying the adhesive composition as long as a common coating method is employed. Examples of the coating method include roll coating, die coating, gravure coating, comma coating, slot coating, and screen printing.

In order to cross-link (cure) the adhesive composition on the release sheet, active energy rays such as light rays (e.g., far-ultraviolet rays, ultraviolet rays, near-ultraviolet rays, and infrared rays) and electromagnetic waves (e.g., X-rays and γ-rays), as well as an electron beam, a proton beam, a neutron beam, and the like can be used. However, it is preferable to cure the adhesive composition using ultraviolet rays in terms of the curing rate, availability of an irradiation apparatus, cost, and the like.

The gel fraction of the adhesive layer of the adhesive sheet is preferably 10 to 100 wt. %, particularly preferably 30 to 90 wt. %, and more preferably 50 to 80 wt. %, in terms of durability and adhesiveness. If the gel fraction is too low, the durability tends to decrease due to a decrease in a cohesive force. Note that, if the gel fraction is too high, the adhesiveness tends to decrease due to an increase in a cohesive force.

The gel fraction can be adjusted to be within the range above by adjusting the irradiation amount of an active energy ray, the content of the active energy ray cross-linkable structural moiety in the acrylic resin (A), or the types and amounts of the cross-linking agent and the photopolymerization initiator.

The gel fraction serves as an index of the degree of cross-linking (curing), and is calculated, for example, using the following method. That is to say, an adhesive sheet (that is not provided with a release sheet) obtained by forming an adhesive layer on a polymer sheet (e.g., polyethylene terephthalate (PET) film) serving as a base material is wrapped with a 200-mesh SUS wire netting and is then immersed in toluene kept at 23° C. for 24 hours. The weight percentage of undissolved adhesive components remaining in the wire netting is taken as the gel fraction. Note that the weight of the base material is subtracted in advance.

In general, the thickness of the adhesive layer of the adhesive sheet is preferably 25 to 3000 μm, more preferably 50 to 1000 μm, and even more preferably 75 to 300 μm. If the adhesive layer is too thin, the shock absorbency tends to decrease. If the adhesive layer is too thick, the practicality tends to decrease due to an increase in the total thickness of an optical member.

In the present disclosure, the thickness of the adhesive layer is determined by subtracting the measured value of the thicknesses of the constituent components other than the adhesive layer from the measured value of the entire thickness of the adhesive layer-containing laminate using “ID-C112B” manufactured by Mitutoyo Corporation.

The relative dielectric constant of the adhesive layer at 1 MHz is preferably 3.0 or less, particularly preferably 2.7 or less, and even more preferably 2.5 or less. Note that the lower limit of the relative dielectric constant is usually 1.0.

If the relative dielectric constant at 1 MHz is too high, the electrostatic capacitance between electrodes provided on a touch panel tends to increase, which causes a malfunction. If the relative dielectric constant is too low, the electrostatic capacitance tends to decrease, which causes a decrease in detection sensitivity.

The relative dielectric constant of the adhesive layer at 10 GHz is preferably 3.0 or less, and particularly preferably 2.8 or less. Note that the lower limit of the relative dielectric constant is usually 1.0.

If the relative dielectric constant at 10 GHz is too high, transmission loss tends to increase in an antenna, a sensor, wiring, and the like that are in contact with the adhesive layer.

The dielectric dissipation factor of the adhesive layer at 10 GHz is preferably 0.005 or less, particularly preferably 0.004 or less, and more preferably 0.003 or less.

If the dielectric dissipation factor at 10 GHz is too high, transmission loss tends to increase in an antenna, a sensor, wiring, and the like that are in contact with the adhesive layer.

When the adhesive layer of the adhesive sheet according to the present disclosure has a thickness of 150 μm, the haze value of the adhesive layer is preferably 2% or less, particularly preferably 0 to 1.5%, and more preferably 0 to 1%. If the haze value exceeds 2%, the transparency tends to decrease due to whitening of the adhesive layer.

In the present disclosure, an optical member with an adhesive layer can be obtained by forming and laminating the adhesive layer on an optical member. Also, optical members can be bonded together using the double-sided adhesive sheet.

Examples of the optical members include a display (an organic EL display, liquid crystal display), a transparent conductive film substrate (ITO substrate), a protective film (glass), a transparent antenna (film), and transparent wiring that are included in a touch panel and an image display device.

### EXAMPLES

Hereinafter, the present disclosure will be described in further detail by way of examples, but the present disclosure is not limited to the examples below and may include other matter that does not depart from the gist of the present disclosure. Note that, in the descriptions of the examples, “parts” and “%” mean “parts by weight” and “wt. %,” respectively. The weight-average molecular weights and the glass-transition temperatures of acrylic resins were measured in accordance with the above-described methods.

### Manufacturing Example 1

### Manufacturing of Acrylic Resin [A-1]

In a 2-L flask provided with a cooler, 27 parts of ethyl acetate (boiling point: 77° C.) and 3 parts of acetone (boiling point: 56° C.), which served as a polymerization solvent, 0.02 parts of 2,2′-azobisisobutyronitrile (AlBN, half-life temperature: 65° C.), which served as a polymerization initiator, and 40% of 100 parts of a previously mixed monomer solution (a mixed solution of 20 parts of stearyl methacrylate (SMA: a1-2), 53.55 parts of a mixture of lauryl methacrylate and tridecyl methacrylate (SLMA: al-1), 1 part of 4-hydroxybutyl acrylate (4HBA: a2), 20 parts of 2-ethylhexyl methacrylate (2EHMA: a3), 5 parts of ethyl methacrylate (EMA: a3), and 0.45 parts of 4-methacryloyloxy benzophenone (MBP: a4)) were placed. The resultant mixture was heated to reflux in the flask, and then 0.05 parts of 2,2′-azobis(2,4-dimethylvaleronitrile) (ADVN: 10-hour half-life temperature: 52° C.), which served as a polymerization initiator, and the remaining 60% of the monomer solution were dripped into the mixture over 2 hours. An hour after the dripping was finished, a mixture of 10 parts of ethyl acetate and 0.2 parts of ADVN was dripped over 1 hour and reacted. Thus, a solution of an acrylic resin [A-1] (weight-average molecular weight: 420,000; degree of dispersion: 4.20; concentration of a solid content: 57%; viscosity: 5100 mPa·s (25° C.); glass-transition temperature: −3° C.) was obtained. The content of methacrylic acid alkyl ester monomers in the copolymerization component was 98.55%, and the average of the number of carbon atoms in the alkyl chains of the methacrylic acid alkyl ester monomers was 12.1. The composition and physical properties of the obtained acrylic resin [A-1] are shown in Table 1 below.

### Manufacturing Examples 2 to 10

Acrylic resins [A-2] to [A-10] were manufactured in the same manner as in Manufacturing Example 1, except that the copolymerization components for an acrylic resin were prepared as shown in Table 1 below. The physical properties of the obtained acrylic resins [A-2] to [A-10] are shown in Table 1 below.

TABLE 1

| | | Composition of copolymerization component (parts) | | | | | | | | | |
|---|---|---|---|---|---|---|---|---|---|---|---|
| | | (a1) | | | | | | | | | |
| | Acrylic | (a1-1) | (a1-2) | (a2) | | | | (a3) | | (a4) | (a5) |
| | resin | SLMA | SMA | 4HBA | HEA | HEMA | DMAA | 2EHMA | EMA | MBP | 2EHA |
| Manu. | A-1 | 53.55 | 20 | 1 | — | — | — | 20 | 5 | 0.45 | — |
| Ex. 1 | | | | | | | | | | | |
| Manu. | A-2 | 59.05 | 20 | 0.5 | — | — | — | 10 | 10 | 0.45 | — |
| Ex. 2 | | | | | | | | | | | |
| Manu. | A-3 | 59.05 | 20 | — | 0.5 | — | — | 15 | 5 | 0.45 | — |
| Ex. 3 | | | | | | | | | | | |
| Manu. | A-4 | 59.05 | 20 | — | — | 0.5 | 0.5 | 15 | 5 | 0.45 | — |
| Ex. 4 | | | | | | | | | | | |
| Manu. | A-5 | 70.05 | 20 | — | — | 0.5 | — | — | 9 | 0.45 | — |
| Ex. 5 | | | | | | | | | | | |
| Manu. | A-6 | 70.05 | 20 | — | 0.5 | — | — | — | 9 | 0.45 | — |
| Ex. 6 | | | | | | | | | | | |
| Manu. | A-7 | 98.55 | — | 1 | — | — | — | — | — | 0.45 | — |
| Ex. 7 | | | | | | | | | | | |
| Manu. | A-8 | 48.55 | — | 1 | — | — | — | — | — | 0.45 | 50 |
| Ex. 8 | | | | | | | | | | | |
| Manu. | A-9 | 96.55 | — | 3 | — | — | — | — | — | 0.45 | — |
| Ex. 9 | | | | | | | | | | | |
| Manu. | A-10 | 56.55 | — | 3 | — | — | — | 20 | 10 | 0.45 | 10 |
| Ex. 10 | | | | | | | | | | | |

| | | | Weight- | | |
|---|---|---|---|---|---|
| | | Average | average | | Glass- |
| | | number | molecular | | transition |
| | Content*¹ | of carbon | weight | Degree of | temperature |
| | (%) | atoms*² | (×10⁴) | dispersion | (° C.) |
| Manu. | 98.55 | 12.1 | 42 | 4.20 | −3 |
| Ex. 1 | | | | | |
| Manu. | 99.05 | 12.1 | 36 | 3.79 | −3 |
| Ex. 2 | | | | | |
| Manu. | 99.05 | 12.4 | 41 | 3.78 | −6 |
| Ex. 3 | | | | | |
| Manu. | 99.05 | 12.4 | 44 | 4.49 | −5 |
| Ex. 4 | | | | | |
| Manu. | 99.55 | 12.6 | 59 | 4.70 | −6 |
| Ex. 5 | | | | | |
| Manu. | 99.55 | 12.6 | 59 | 4.86 | −6 |
| Ex. 6 | | | | | |
| Manu. | 98.55 | 12.5 | 45 | 4.56 | −12 |
| Ex. 7 | | | | | |
| Manu. | 48.55 | 12.5 | 39 | 3.91 | −33 |
| Ex. 8 | | | | | |
| Manu. | 96.55 | 12.5 | 44 | 4.60 | −8 |
| Ex. 9 | | | | | |
| Manu. | 86.55 | 12.1 | 62 | 5.19 | −2 |
| Ex. 10 | | | | | |

SLMA: product with lauryl methacrylate/tridecyl methacrylate = 55/45 (average number of carbon atoms in alkyl chains: 12.5),
SMA: stearyl methacrylate (average number of carbon atoms in alkyl chains: 18),
4HBA: 4-hydroxybutyl acrylate,
HEA: 2-hydroxyethyl acrylate,
HEMA: hydroxylethyl methacrylate (number of carbon atoms in alkyl chain: 2),
DMAA: dimethylacrylamide,
2EHMA: 2-ethylhexyl methacrylate (number of carbon atoms in alkyl chain: 8),
EMA: ethyl methacrylate (number of carbon atoms in alkyl chain: 2),
MBP: 4-methacryloyloxy benzophenone,
2EHA: 2-ethylhexyl acrylate
*¹Content of methacrylic acid alkyl ester monomers in copolymerization component
*²Average number of carbon atoms in alkyl chains of methacrylic acid alkyl ester monomers in copolymerization component

Next, prior to preparation of adhesive compositions, components were prepared as described below.

Hydrophilicity Imparting Agent (B)
Polyethylene glycol diacrylate (B1-1): “A400, manufactured by SHIN-NAKAMURA CHEMICAL CO, LTD.” (compound having a structure represented by —(C₂H₄O)₉— and two ethylenic unsaturated groups)

### Example 1

The concentration of a solid content in the solution of the acrylic resin (A-1) obtained as described above was adjusted to 45% using ethyl acetate. Then, 1 part of polyethylene glycol diacrylate (B1-1) was mixed into the resultant solution, and thus an adhesive composition solution was obtained. This adhesive composition solution was applied to a polyester release sheet so as to have a thickness about 75 μm after drying, and was dried at 100° C. for 5 minutes. Thus, an adhesive composition layer was formed. After two adhesive composition layers obtained in this manner were laminated, the laminate was sandwiched between polyester release sheets, and then was irradiated with ultraviolet rays at a peak illuminance of 150 mW/cm² such that the integrated exposure amount was 1000 mJ/cm² (500 mJ/cm²×2 passes), using a high-pressure mercury UV irradiation apparatus. Thus, an adhesive layer was formed, and a double-sided adhesive sheet free from a base material was obtained.

The release sheet was removed from the adhesive layer on one of the surfaces of the thus obtained double-sided adhesive film free from a base material, and then this adhesive film was pressed onto a polyethylene terephthalate (PET) sheet (with a thickness of 125 μm) subjected to adhesion promotion treatment. Thus, a PET sheet with an adhesive layer in which the adhesive layer had a thickness of 150 μm was obtained.

### Examples 2 to 7, Comparative Examples 1 to 6

Adhesive compositions having the blend compositions listed in Table 2 below were prepared in the same manner as in Example 1 above, and then double-sided adhesive sheets free from a base material and PET sheets with an adhesive layer were obtained in the same manner as in Example 1.

The thus obtained double-sided adhesive sheets free from a base material and PET sheets with an adhesive layer of the examples and comparative examples were evaluated as follows.

### Gel Fraction

After the double-sided adhesive sheet free from a base material was cut into pieces having a size of 40 mm×40 mm, each cut piece was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus, and was then left to stand for 30 minutes under the conditions of 23° C. and 50% RH. Thereafter, one of the release sheets was removed, and the adhesive layer side was bonded to an SUS mesh sheet (200 mesh) having a size of 50 mm×100 mm. Then, the other of the release sheets was removed, and the SUS mesh sheet was folded back at the center in the longitudinal direction so as to wrap the sample, and was immersed in 250 g of toluene kept at 23° C. in a hermetically sealed container for 24 hours. A change in weight was measured to determine the gel fraction (%).

### Dielectric Properties (Low Frequency: 1 MHz) [Relative Dielectric Constant (ε′)]

After the double-sided adhesive sheets free from a base material were stacked until the thickness of the adhesive layer reached 600 μm, one of the release sheets was removed, and the adhesive layer was pressed onto an untreated polyethylene terephthalate (PET) sheet (with a thickness of 50 μm). Then, the other of the release sheets was removed, and the adhesive layer was pressed onto another untreated polyethylene terephthalate (PET) sheet of the same type as the PET sheet above. Thus, a PET sheet with an adhesive layer for measurement of dielectric properties having a layer configuration “PET sheet/adhesive layer/PET sheet” was obtained.

The PET sheet with an adhesive layer for measurement of dielectric properties was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus, and was then cut into pieces having a size of 70 mm×70 mm. Each cut piece was used as a test piece for measurement of dielectric properties (low frequency: 1 MHz).

The impedance of the test piece for measurement of dielectric properties (low frequency: 1 MHz) was measured using a HP4284A Precision LCR Meter (manufactured by Agilent) as follows: the test piece was placed between electrodes in an atmosphere of 23° C. and 50% RH and an electric field was applied at a frequency of 1 MHz to measure the impedance. The dielectric constant of the adhesive layer was calculated from a change in electric capacity between the electrodes. The relative dielectric constant (ε′) was calculated from the obtained dielectric constant and was evaluated using the following criteria.

Evaluation Criteria
A (very good) . . . The relative dielectric constant at 1 MHz of the adhesive layer was 2.7 or less.
B (good) . . . The relative dielectric constant at 1 MHz of the adhesive layer was 2.7 or more and 3.0 or less.
C (poor) . . . The relative dielectric constant at 1 MHz of the adhesive layer was greater than 3.0.

### Dielectric Properties (High Frequency: 10 GHz) [Relative Dielectric Constant (ε′), Dielectric Dissipation Factor (tan δ)]

After the double-sided adhesive sheets free from a base material were stacked until the thickness of the adhesive layer reached 600 μm, one of the release sheets was removed, and the adhesive layer was pressed onto an untreated polyethylene terephthalate (PET) sheet (with a thickness of 50 μm). Then, the other of the release sheets was removed, and the adhesive layer was pressed onto another untreated polyethylene terephthalate (PET) sheet of the same type as the PET sheet above. Thus, a PET sheet with an adhesive layer for measurement of dielectric properties having a configuration “PET sheet/adhesive layer/PET sheet” was obtained.

The PET sheet with an adhesive layer for measurement of dielectric properties was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus, and was then cut into pieces having a size of 2 mm×80 mm. Each cut piece was used as a test piece for measurement of dielectric properties (high frequency: 10 GHz).

An E8361A PNA Series Network Analyzer (manufactured by Agilent) was used to calculate the dielectric constants (relative dielectric constant (ε40 ), dielectric dissipation factor (tan δ)) at 10 GHz of the adhesive layer of the test piece for measurement of dielectric properties (high frequency: 10 GHz) using a cavity resonator perturbation method, and the dielectric constants were evaluated using the following criteria.

Evaluation Criteria for Relative Dielectric Constant (ε′)
A (very good) . . . The relative dielectric constant at 10 GHz of the adhesive layer was 2.2 or less.
B (poor) . . . The relative dielectric constant at 10 GHz of the adhesive layer was greater than 2.2.

Evaluation Criteria for Dielectric Dissipation Factor (tan δ)
A (very good) . . . The dielectric dissipation factor at 10 GHz of the adhesive layer was 0.005 or less.
B (poor) . . . The relative dielectric constant at 10 GHz of the adhesive layer was greater than 0.005.

### 180° Peel Strength at 23° C.

The PET sheet with an adhesive layer was cut into pieces having a width of 25 mm and a length of 100 mm, and each cut piece was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus. Then, the release sheet was removed, and the adhesive layer was bonded to alkali-free glass (“Eagle XG” manufactured by Corning Incorporated; thickness: 1.1 mm) under pressure by moving a 2-kg rubber roller back and forth twice in an atmosphere of 23° C. and 50% RH and was left to stand for 30 minutes under conditions of 23° C. and 50% RH. Thereafter, the 180° peel strength (N/25 mm) was measured at a peeling speed of 300 mm/min at ordinary temperature (23° C.).

### 80° C. Holding Force

The PET sheet with an adhesive layer was cut into pieces having a size of 25 mm×50 mm, and each cut piece was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus. Then, the release sheet was removed, and the PET sheet was bonded to a stainless-steel plate (SUS304) (bonding area: 25 mm×25 mm) under pressure by moving a 2-kg roller back and forth. Thereafter, a creep tester (tester with a high-temperature and constant-humidity oven BE-501 manufactured by Tester Sangyo Co., Ltd.) was used to apply a load of 1 kg in an atmosphere of 80° C., and the holding force was measured over 24 hours. The evaluation criteria were as follows.

Evaluation Criteria
A (excellent) . . . The PET sheet did not move.
B (very good) . . . The PET sheet moved by less than 0.1 mm.
C (good) . . . The PET sheet moved by 0.1 mm or more and less than 1.0 mm.
D (poor) . . . The PET sheet moved by 1.0 mm or more, or fell off.

### Optical Properties (Transparency) of Adhesive Layer

The PET sheet with an adhesive layer was cut into pieces having a size of 25 mm×25 mm, and each cut piece was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus. Then, the release sheet was removed from one of the surfaces of the adhesive layer, and the adhesive layer was bonded to alkali-free glass (“Eagle XG” manufactured by Corning Incorporated; thickness: 1.1 mm) and was then subjected to autoclave treatment (50° C., 0.5 MPa, 20 minutes). Thus, a test piece having a configuration “alkali-free glass/adhesive layer/PET” was produced.

### Haze Value

The haze value was measured using the obtained test piece.

The haze value was determined as follows: the diffuse transmittance and the total light transmittance were measured using a HAZE MATER NDH4000 (manufactured by NIPPON DENSHOKU INDUSTRIES Co., Ltd.), and the obtained values of the diffuse transmittance and the total light transmittance were substituted into Formula 1 below to calculate the haze. Note that this apparatus conforms to JIS K7361-1.

Haze value (%)=(diffuse transmittance/total light transmittance)×100 (Formula 1)

### Moisture-and-Heat Resistant Haze Properties

The PET sheet with an adhesive layer was cut into pieces having a size of 30 mm×50 mm, and each cut piece was irradiated with ultraviolet rays at a peak illuminance of 150 mW/cm² such that the integrated exposure amount was 4000 mJ/cm² (1000 mJ/cm²×4 passes), using a high-pressure mercury UV irradiation apparatus. Then, the release sheet was removed, and the adhesive layer was bonded to alkali-free glass (“Eagle XG” manufactured by Corning Incorporated; thickness: 1.1 mm) and was then subjected to autoclave treatment (50° C., 0.5 MPa, 20 minutes) and was left to stand for 30 minutes under conditions of 23° C. and 50% RH. Thus, a test piece having a configuration “alkali-free glass/adhesive layer/PET” was produced.

A moisture-and-heat resistance test was performed using the obtained test piece in an atmosphere of 85° C. and 85% RH for 7 days (168 hours). The haze value was measured before the moisture-and-heat resistance test was started and after the test piece subjected to the moisture-and-heat resistance test was left to stand for 2 hours under conditions of 23° C. and 50% RH. The haze value was determined as follows: the diffuse transmittance and the total light transmittance were measured using a HAZE MATER NDH4000 (manufactured by NIPPON DENSHOKU INDUSTRIES Co., Ltd.), and the obtained values of the diffuse transmittance and the total light transmittance were substituted into Formula 2 below to calculate the haze. Thereafter, an increase in the haze value was calculated using Formula 3 below. Note that this apparatus conforms to JIS K7361-1.

Haze value (%)=(diffuse transmittance/total light transmittance)×100 (Formula 2)

Increase in haze value (%)={(haze value after moisture-and-heat resistance test−haze value before start of moisture-and-heat resistance test)/haze value before start of moisture-and-heat resistance test}×100 (Formula 3)

Evaluation Criteria
A (very good) . . . The increase in the haze value was less than 1.5%.
B (good) . . . The increase in the haze value was 1.5% or more and less than 2.5.
C (poor) . . . The increase in the haze value was more than 2.5%.

TABLE 2

| | | | Physical properties | | | | | | |
|---|---|---|---|---|---|---|---|---|---|
| | Adhesive composition | | | Dielectric properties | | | | | |
| | | Hydro- | | (1 MHz) | | Dielectric properties (10 GHz) | | | |
| | | philicity | Gel | Relative | | Relative | | Dielectric | |
| | Acrylic | imparting | fraction | dielectric | | dielectric | | dissipation | |
| | resin | agent | (%) | constant ε′ | Evaluation | constant ε′ | Evaluation | factor tanδ | Evaluation |
| Ex. 1 | A-1 | B1-1 | 80.1 | 2.5 | A | 1.9 | A | 0.005 | A |
| | | (1) | | | | | | | |
| Ex. 2 | A-2 | B1-1 | 78.4 | 2.5 | A | 2.1 | A | 0.005 | A |
| | | (0.5) | | | | | | | |
| Ex. 3 | A-2 | B1-1 | 78.4 | 2.5 | A | 2.1 | A | 0.005 | A |
| | | (1) | | | | | | | |
| Ex. 4 | A-3 | B1-1 | 80.6 | 2.5 | A | 2.0 | A | 0.004 | A |
| | | (0.5) | | | | | | | |
| Ex. 5 | A-4 | B1-1 | 79.6 | 2.4 | A | 2.1 | A | 0.004 | A |
| | | (0.5) | | | | | | | |
| Ex. 6 | A-5 | B1-1 | 83.6 | 2.4 | A | 2.1 | A | 0.004 | A |
| | | (0.5) | | | | | | | |
| Ex. 7 | A-6 | B1-1 | 83.6 | 2.4 | A | 2.1 | A | 0.004 | A |
| | | (0.5) | | | | | | | |
| Comp. | A-1 | — | 79.1 | 2.4 | A | 2.0 | A | 0.004 | A |
| Ex. 1 | | | | | | | | | |
| Comp. | A-10 | B1-1 | 85.1 | 2.5 | A | 2.2 | A | 0.007 | B |
| Ex. 2 | | (0.5) | | | | | | | |
| Comp. | A-10 | — | 84.4 | 2.5 | A | 2.2 | A | 0.006 | B |
| Ex. 3 | | | | | | | | | |
| Comp. | A-7 | — | 77.9 | 2.5 | A | 2.0 | A | 0.004 | A |
| Ex. 4 | | | | | | | | | |
| Comp. | A-8 | — | 80.9 | 2.9 | B | 1.9 | A | 0.008 | B |
| Ex. 5 | | | | | | | | | |
| Comp. | A-9 | — | 81.7 | 2.5 | A | 2.0 | A | 0.006 | B |
| Ex. 6 | | | | | | | | | |

| | Physical properties | | | | | | |
|---|---|---|---|---|---|---|---|
| | | | | | Moisture-and-heat resistant haze properties | | |
| | 180° peel | 80° C. holding force | | | Haze value after | Increase | |
| | strength at 23° C. | Move (mm) | | Transparency | moisture-and-heat | in haze | |
| | (N/25 mm) | or fall down | Evaluation | Haze value (%) | resistance test (%) | value (%) | Evaluation |
| Ex. 1 | 17.3 | Not move | A | 0.4 | 1.5 | 1.0 | A |
| Ex. 2 | 19.7 | Not move | A | 0.5 | 2.4 | 1.9 | B |
| Ex. 3 | 18.3 | Not move | A | 0.5 | 1.7 | 1.2 | A |
| Ex. 4 | 17.1 | Not move | A | 0.5 | 1.8 | 1.2 | A |
| Ex. 5 | 18.1 | Not move | A | 0.4 | 1.8 | 1.3 | A |
| Ex. 6 | 15.2 | Not move | A | 0.5 | 2.1 | 1.5 | B |
| Ex. 7 | 14.0 | Not move | A | 0.5 | 1.5 | 1.1 | A |
| Comp. | 20.1 | Not move | A | 0.4 | 24.5 | 24.1 | C |
| Ex. 1 | | | | | | | |
| Comp. | 19.7 | Not move | A | 0.6 | 2.2 | 1.7 | B |
| Ex. 2 | | | | | | | |
| Comp. | 20.3 | Fall down | D | 0.7 | 12.5 | 11.9 | C |
| Ex. 3 | | | | | | | |
| Comp. | 15.5 | Less than 0.05 | B | 0.5 | 20.3 | 19.8 | C |
| Ex. 4 | | | | | | | |
| Comp. | 1.8 | Fall down | D | 0.4 | 16.9 | 16.5 | C |
| Ex. 5 | | | | | | | |
| Comp. | 15.6 | Fall down | D | 0.5 | 16.8 | 16.3 | C |
| Ex. 6 | | | | | | | |

The numbers in parentheses represent blend parts with respect to 100 parts by weight of the acrylic resin.

The adhesive sheets formed using the adhesive compositions of Examples 1 to 7 had excellent adhesive properties and excellent moisture-and-heat resistance while having a low dielectric constant and a low dielectric dissipation factor in the low-frequency area and the high-frequency area, and were well-balanced.

On the other hand, the adhesive sheets formed using the adhesive compositions of Comparative Examples 1 and 3 to 6, which did not contain a certain hydrophilicity imparting agent, had poor adhesive properties and poor moisture-and-heat resistance compared with Examples 1 to 7. Also, the adhesive sheets formed using the adhesive compositions of Comparative Examples 2 and 3, which contained an excessive amount of the polar group-containing (meth)acrylic acid ester monomer (a2) as the copolymerization component of the acrylic resin, had poor dielectric properties at a high frequency compared with Examples 1 to 7. Furthermore, the adhesive sheets formed using the adhesive compositions of Comparative Examples 4 to 6, which did not contain the methacrylic acid alkyl ester monomer (a3) as the copolymerization component of the acrylic resin, had poor adhesive properties compared with Examples 1 to 7.

While specific modes of the present disclosure are described in the examples above, the examples above are for illustrative purposes only and should not be construed as being restrictive. Various alterations that are apparent to those skilled in the art are all intended to fall within the scope of the present disclosure.

### INDUSTRIAL APPLICABILITY

An adhesive formed using the adhesive composition according to the present disclosure has excellent adhesive properties and exhibits a low dielectric constant and a low dielectric dissipation factor, and is particularly useful as an adhesive to be used to bond optical members included in a touch panel, image display device, and the like, and to seal an organic EL display.

1. An adhesive composition comprising:
an acrylic resin (A); and
a hydrophilicity imparting agent (B),
wherein the acrylic resin (A) comprises a copolymer of a copolymerization component (a) containing a methacrylic acid alkyl ester monomer having an alkyl chain with 10 to 36 carbon atoms (a1), and a polar group-containing ethylenic unsaturated monomer (a2),
a content of the polar group-containing ethylenic unsaturated monomer (a2) is less than 3 wt. % with respect to the copolymerization component (a), and
the hydrophilicity imparting agent (B) contains a compound (B1) that has a structure represented by —(CₙH₂ₙO)ₘ— (n is 2 to 6 and m is 2 to 25) and contains at least one ethylenic unsaturated group.

2. The adhesive composition according to claim 1,
wherein a content of the methacrylic acid alkyl ester monomer having an alkyl chain with 10 to 36 carbon atoms (a1) in the copolymerization component (a) is 50 to 95 wt. % with respect to the copolymerization component (a).

3. The adhesive composition according to claim 1,
wherein the methacrylic acid alkyl ester monomer having an alkyl chain with 10 to 36 carbon atoms (a1) contains a methacrylic acid alkyl ester monomer having an alkyl chain with 10 to 15 carbon atoms (a1-1) and a methacrylic acid alkyl ester monomer having an alkyl chain with 16 to 36 carbon atoms (a1-2).

4. The adhesive composition according to claim 1,
wherein a content of methacrylic acid alkyl ester monomers in the copolymerization component (a) is 80 to 99 wt. % with respect to the copolymerization component (a), and an average number of carbon atoms in alkyl chains of the methacrylic acid alkyl ester monomers is 10 to 15.

5. The adhesive composition according to claim 1,
wherein the acrylic resin (A) has an active energy ray cross-linkable structural moiety.

6. The adhesive composition according to claim 5,
wherein the active energy ray cross-linkable structural moiety comprises a benzophenone cross-linkable structural moiety.

7. The adhesive composition according to claim 1,
wherein the acrylic resin (A) has a weight-average molecular weight of 150,000 to 1,500,000.

8. An adhesive formed by cross-linking the adhesive composition according to claim 1.

9. An adhesive formed by cross-linking the adhesive composition according to claim 1 using an active energy ray.

10. An adhesive sheet comprising an adhesive layer comprising the adhesive according to claim 8.

11. An adhesive sheet for an image display device, comprising an adhesive layer comprising the adhesive according to claim 8.

12. An adhesive sheet comprising an adhesive layer made of the adhesive according to claim 9.

13. An adhesive sheet for an image display device, comprising an adhesive layer made of the adhesive according to claim 9.
